(19) United States
(12) Patent Application Publication
(10) Pub. No.: US 2026/0106230 A1
(43) Pub. Date: Apr. 16, 2026

(54) ULTRASONIC SOLID-STATE BATTERY STRUCTURE CAPABLE OF REMOVING LITHIUM DENDRITES

(71) Applicant: Zhijun Peng, Foshan (CN)

(72) Inventor: Zhijun Peng, Foshan (CN)

(21) Appl. No.: 19/000,539

(22) Filed: Dec. 23, 2024

(30) Foreign Application Priority Data
Oct. 14, 2024 (CN) 202411431367.9

(51) Int. Cl. H01M 10/42; H01M 10/052; H01M 10/0585

(52) U.S. Cl. CPC H01M 10/4235; H01M 10/052; H01M 10/0585; H01M 10/4214

(57) ABSTRACT

An ultrasonic solid-state battery structure capable of removing lithium dendrites, comprising two ultrasonic electrode bodies, a solid electrolyte disposed between the two ultrasonic electrode bodies, and a separation assembly connected to the two ultrasonic electrode bodies, wherein the separation assembly drives each of the two ultrasonic electrode bodies either to closely contact or to separate from the solid electrolyte, and when in a separated state, a separation gap is formed between the ultrasonic electrode bodies and the solid electrolyte.

### FIELD OF THE INVENTION

The present invention relates to the field of battery technology, and more particularly to an ultrasonic solid-state battery structure designed to remove lithium dendrites.

### BACKGROUND OF THE INVENTION

Currently, the primary distinction between solid-state lithium batteries and liquid-state lithium batteries is that solid-state lithium batteries use a solid electrolyte instead of the traditional liquid organic electrolyte, thereby overcoming issues such as leakage, flammability, and a narrow operating temperature range associated with liquid electrolytes. However, during operation of a solid-state lithium battery, lithium dendrites can still form on the negative electrode. These lithium dendrites may penetrate the solid electrolyte and cause short-circuiting, adversely affecting the service life of the solid-state battery.

As a solution, Chinese Patent Document with Application No. 201910210719.0 and titled “A Solid Electrolyte and a Fully Solid-State Lithium Metal Battery Thereof” discloses a technical approach that mainly includes a positive electrode, a negative electrode, and first and second electrolyte layers disposed between the electrodes. By increasing the number of electrolyte layers, the overall thickness of the solid-state electrolyte is increased, thereby extending the time needed for lithium dendrites to penetrate and prolonging the battery's service life. However, in practical applications, this solution has the following shortcomings:

With an increased overall thickness of the solid-state electrolyte, although the dendrites take longer to penetrate, allowing them to keep growing and accumulating can ultimately lead to short-circuiting; the dendrites have not actually been removed, resulting in lower reliability.

As the number of lithium dendrites grows, they block the movement of lithium ions, causing battery capacity loss and reduced charge-discharge efficiency.

Hence, the existing solid-state battery is not the optimal solution.

### SUMMARY OF THE INVENTION

In view of the aforementioned issues and deficiencies, the present invention provides an ultrasonic solid-state battery structure that removes lithium dendrites. In this structure, separation gaps are used to ensure sufficient space for the detached lithium dendrites to drop off for easier removal; the cavitation effect produced by ultrasonic waves prevents lithium dendrites and chemical impurities from adhering to the ultrasonic electrode components, thus effectively achieving lithium dendrite removal. This prevents lithium dendrites and chemical impurities from continuously accumulating, thereby avoiding blockages and piercing damage to the solid-state electrolyte, greatly enhancing the battery's safety and prolonging its service life.

The technical solution of the present invention is realized as follows: An ultrasonic solid-state battery structure capable of removing lithium dendrites, comprising two ultrasonic electrode components and a solid electrolyte disposed between them. Characteristically, it further includes a separation assembly that connects to the two ultrasonic electrode components. Via this separation assembly, the two ultrasonic electrode components can be driven either to closely contact or to separate from the solid electrolyte. When in the separated state, a separation gap is formed between each ultrasonic electrode component and the solid electrolyte.

Preferably, the solid electrolyte also incorporates an ultrasonic vibration element inside.

Preferably, the separation assembly includes two miniature electric push rods, whose movable ends are respectively fixed to the two ultrasonic electrode components.

Preferably, a compression spring is provided between each miniature electric push rod and the corresponding ultrasonic electrode component.

Preferably, the invention also includes a battery housing having a receiving cavity, and a battery housing cover. The two ultrasonic electrode components, the solid electrolyte, and the separation assembly are respectively fitted within the receiving cavity. The battery housing cover is placed over the opening of the receiving cavity, and two terminals, electrically connected to the two ultrasonic electrode components, are provided on the battery housing cover.

Preferably, guiding protrusions and guiding grooves are provided between the two ultrasonic electrode components and the bottom of the receiving cavity so that the ultrasonic electrode components can slide in matching alignment. Similarly, guiding protrusions and guiding grooves are also provided between the two ultrasonic electrode components and the battery housing cover.

Preferably, a limiting protrusion and a limiting groove, which mutually engage, are provided between the solid electrolyte and the receiving cavity.

Preferably, an air inlet is provided on the battery housing cover and is in fluid connection with the receiving cavity, and a debris-blowing outlet is provided at the bottom of the battery housing and is also connected to the receiving cavity. Both the air inlet and the debris-blowing outlet are equipped with reusable sealing caps. Additionally, a funnel-shaped guide structure is provided at the bottom of the receiving cavity leading toward the debris-blowing outlet.

Preferably, a support bracket is provided at the bottom of the receiving cavity to support the two ultrasonic electrode components and the solid electrolyte, and perforations for passing and discharging debris are formed on the support bracket.

Preferably, each ultrasonic electrode component and the ultrasonic vibration element respectively include a housing with a working cavity slot, a sliding block disposed in the working cavity slot, and a cover shell mounted over the working cavity slot. A permanent magnet is arranged on the sliding block, and an electromagnetic coil is arranged on the inside of the cover shell so that it interacts with the permanent magnet. Additionally, each end of the sliding block is provided with a buffering elastic piece. Both the housing and the cover shell are coated with conductive coatings.

Beneficial Effects of the Invention: By providing a separation assembly, the present invention allows the ultrasonic electrode components to be separated from the solid electrolyte. Through the separation gap formed between them, sufficient space is created for lithium dendrites to detach and drop off, facilitating easier removal of the dendrites. Meanwhile, the ultrasonic cavitation effect generated by the ultrasonic electrode components in operation prevents lithium dendrites and chemical impurities from adhering to them, thus genuinely achieving removal of lithium dendrites. This prevents the continuous accumulation of lithium dendrites and chemical impurities, thereby avoiding blockage or piercing damage to the solid-state electrolyte, significantly enhancing battery safety and extending its service life.

Moreover, the described structural design allows for periodic dendrite clearance, enabling the use of a relatively thin conventional solid electrolyte. This ensures a sufficiently short transport distance for lithium ions within the electrolyte, reducing battery impedance. Even after prolonged use, it offers high charge-discharge efficiency and power output. In extremely cold weather, the ultrasonic cavitation effect can also be utilized to quickly heat the battery from the inside by accelerating the motion of molecules within the battery.

### BRIEF DESCRIPTION OF THE DRAWINGS

FIG. 1 is a schematic diagram of the overall structure of the present invention;

FIG. 2 is an exploded view of the present invention;

FIG. 3 is a cross-sectional schematic diagram of the A-A section in FIG. 1, showing the ultrasonic electrode component and the solid electrolyte in a separated state;

FIG. 4 is a cross-sectional schematic diagram of the A-A section in FIG. 1, showing the ultrasonic electrode component and the solid electrolyte in a closely contacted state;

FIG. 5 is an exploded view of the ultrasonic electrode component or ultrasonic element of the present invention;

FIG. 6 is a partially sectioned cross-sectional schematic of the ultrasonic electrode component or ultrasonic element of the present invention.

### DETAILED DESCRIPTION OF THE EMBODIMENTS

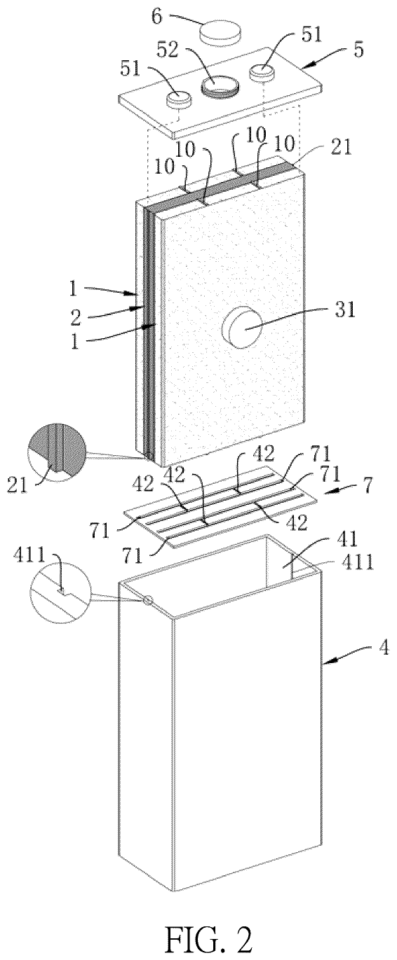

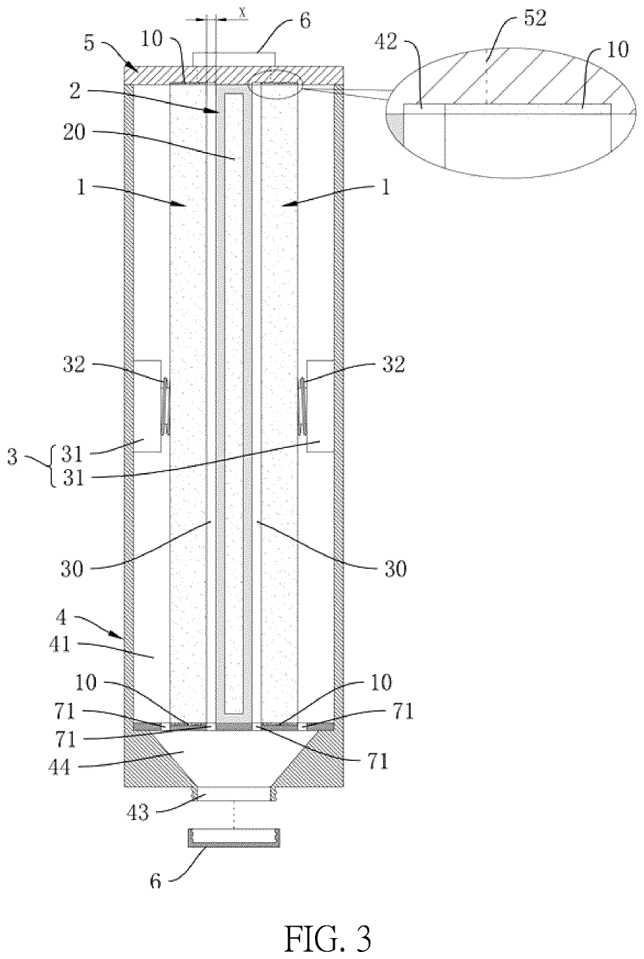

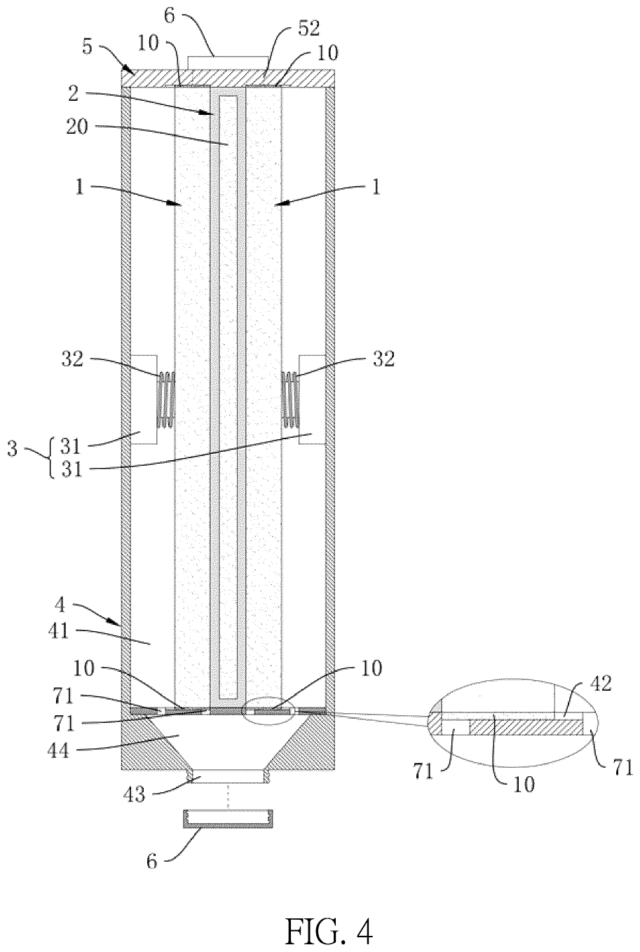

As shown in FIG. 2, the ultrasonic solid-state battery structure proposed in the present invention is a battery cell assembly designed for the assembly of battery products. It comprises two ultrasonic electrode components (1) and a solid electrolyte (2) disposed between them. To achieve the objectives described by the invention, and as shown in FIG. 3 and FIG. 4, the invention further includes a separation assembly (3) connected to the two ultrasonic electrode components (1). This separation assembly (3) is capable of driving the two ultrasonic electrode components (1) to either closely contact or separate from the solid electrolyte (2). When in the separated state, a separation gap (30) is formed between each ultrasonic electrode component (1) and the solid electrolyte (2). Either of the two ultrasonic electrode components (1) can serve as the positive or negative electrode, depending on practical application requirements.

To remove lithium dendrites that have penetrated the solid electrolyte (2), as shown in FIG. 3, the solid electrolyte (2) also has an internal ultrasonic vibration element (20).

For further refinement of the separation assembly (3), and as shown in FIG. 3, the separation assembly (3) includes two miniature electric push rods (31). The movable ends of these two miniature electric push rods (31) are respectively fixed to the two ultrasonic electrode components (1). Based on actual needs, one or both ultrasonic electrode components (1) can be driven separately or simultaneously to realize the desired separation. In practical applications, the width X of the separation gap (30) typically ranges from 2 to 5 mm.

To ensure a tight fit between the ultrasonic electrode components (1) and the solid electrolyte (2), and as shown in FIG. 4, a compression spring (32) is provided between each miniature electric push rod (31) and the corresponding ultrasonic electrode component (1). In practical applications, commonly available miniature electric push rods on the market can be used (e.g., screw-type electric push rods, hydraulic push rods, or pneumatic push rods).

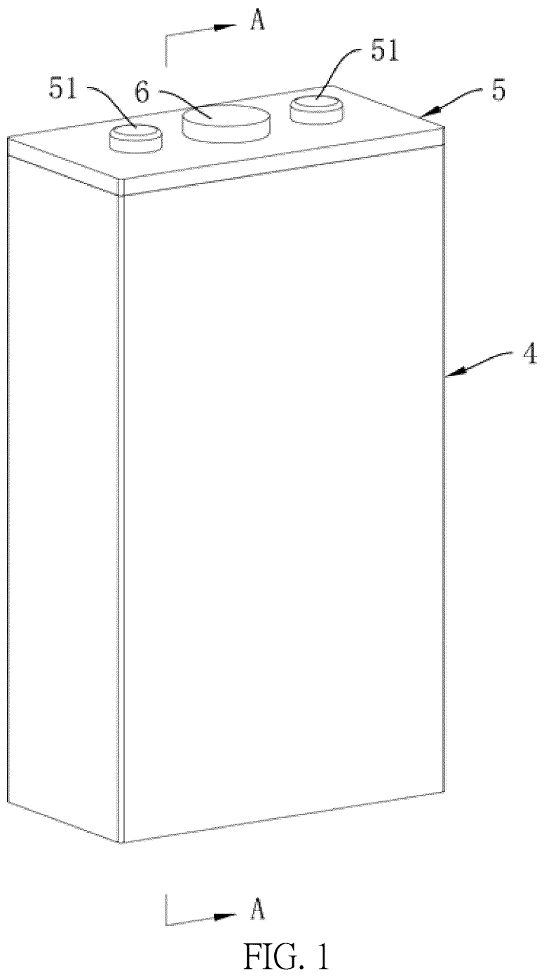

To encapsulate the aforementioned scheme into a complete battery solution, as shown in FIG. 1 and FIG. 2, the invention further includes a battery housing (4) with a receiving cavity (41), and a battery housing cover (5). The two ultrasonic electrode components (1), the solid electrolyte (2), and the separation assembly (3) are respectively fitted inside the receiving cavity (41). The battery housing cover (5) is placed over the mouth of the receiving cavity (41). Furthermore, two terminals (51) that electrically connect to the two ultrasonic electrode components (1) are provided on the battery housing cover (5). Specifically, the two ultrasonic electrode components (1) can be electrically connected to the two terminals (51) using wires.

To allow the two ultrasonic electrode components (1) to move apart or together more smoothly and reliably without tilting, as shown in FIG. 3 and FIG. 4, guiding protrusions (10) and guiding grooves (42) are formed between the two ultrasonic electrode components (1) and the bottom of the receiving cavity (41). Likewise, guiding protrusions (10) and guiding grooves (42) are also formed between the two ultrasonic electrode components (1) and the battery housing cover (5). Specifically, each guiding protrusion (10) can be arranged at the upper and lower ends of the ultrasonic electrode components (1), while the corresponding guiding grooves (42) can be arranged at the bottom of the receiving cavity (41) and on the battery housing cover (5). Of course, the arrangement locations of the guiding protrusions (10) and guiding grooves (42) can be swapped based on actual production needs.

To keep the solid electrolyte (2) in a fixed position both in the separated and closely contacted states, as shown in FIG. 2, a limiting protrusion (21) and a limiting groove (411), which mutually engage, are provided between the solid electrolyte (2) and the receiving cavity (41). Specifically, the limiting protrusion (21) is formed on the solid electrolyte (2), and the limiting groove (411) is formed on the inner wall of the receiving cavity (41).

To further facilitate rapid detachment, dropping, and discharge of lithium dendrites, as shown in FIG. 3, the battery housing cover (5) is provided with an air inlet (52) that connects to the receiving cavity (41). The bottom of the battery housing (4) is provided with a debris-blowing outlet (43) also connected to the receiving cavity (41). Both the air inlet (52) and the debris-blowing outlet (43) have reusable sealing caps (6). A funnel-shaped guide structure (44) is further arranged at the bottom of the receiving cavity (41), leading to the debris-blowing outlet (43). The sealing cap (6) and the air inlet (52)/debris-blowing outlet (43) are threadedly connected. By connecting a fan or blower to the air inlet (52) and debris-blowing outlet (43), high-velocity airflow can be introduced into the receiving cavity (41), accelerating the detachment, dropping, and discharge of lithium dendrites. Removal of lithium dendrites significantly prolongs the battery's service life. The funnel-shaped guide structure (44) helps collect and direct dropped lithium dendrites to the debris-blowing outlet (43) for discharge.

To fix the two ultrasonic electrode components (1) and the solid electrolyte (2) in the receiving cavity (41) without impeding dendrite discharge, as shown in FIG. 3, a support bracket (7) is arranged on the bottom of the receiving cavity (41) to bear the load of the two ultrasonic electrode components (1) and the solid electrolyte (2). This support bracket (7) is formed with perforations (71) for debris passage. For easier manufacturing, the guiding grooves (42) at the bottom of the receiving cavity (41) can be formed on the support bracket (7).

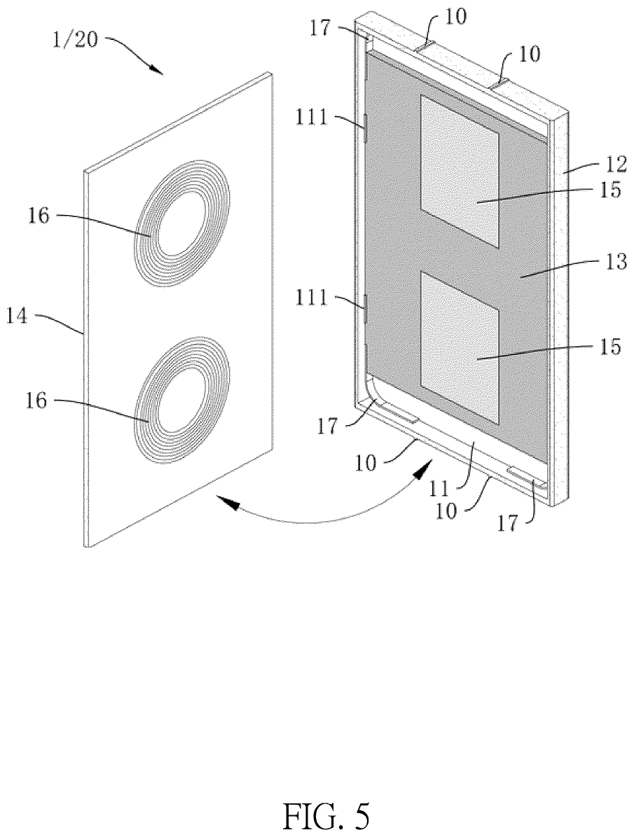

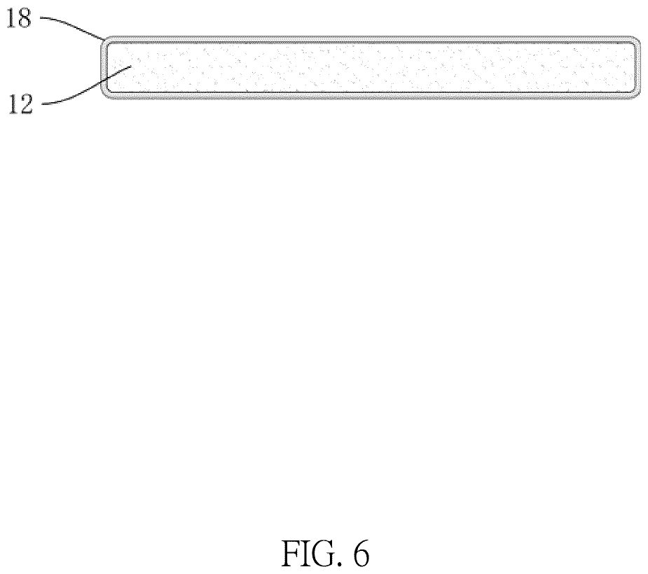

As shown in FIG. 5 and FIG. 6, each ultrasonic electrode component (1) and the ultrasonic vibration element (20) include a housing (12) with a working cavity slot (11), a sliding block (13) disposed in the working cavity slot (11), and a cover shell (14) mounted over the working cavity slot (11). A permanent magnet (15) is arranged on the sliding block (13), while an electromagnetic coil (16) that interacts with the permanent magnet (15) is arranged on the inside of the cover shell (14). Both ends of the sliding block (13) are equipped with elastic pieces (17) for buffering. The surfaces of the housing (12) and the cover shell (14) are coated with conductive coatings (18). These conductive coatings (18) enable contact between the ultrasonic electrode components (1) and the solid electrolyte (2) for charging or discharging. The elastic pieces (17) provide a restoring force when the electromagnetic coil (16) drives the permanent magnet (15) and the sliding block (13) to move, thereby achieving reciprocal motion. Specifically, a limiting protrusion (111) is also arranged in the working cavity slot (11) to prevent the sliding block (13) from detaching from the slot. In use, when current passes through the electromagnetic coil (16) from an external circuit, the coil generates a magnetic field, driving the permanent magnet (15) and the sliding block (13) to move at ultrasonic frequencies within the working cavity slot (11), thereby generating ultrasonic vibrations. These ultrasonic vibrations then propagate through solid media. Both the housing (12) and the cover shell (14) are made of metal materials.

The supply wires for the electromagnetic coil (16) pass outward through the cover shell (14) and are led out of the battery housing (4) via the terminals (51), as shown in FIG. 2.

Apart from the aforementioned internal ultrasonic component (consisting of the sliding block (13), permanent magnet (15), electromagnetic coil (16), and elastic pieces (17)) design, the present invention may also adopt ultrasonic vibration motors or ultrasonic transducers as substitutes.

For convenience in controlling the internal ultrasonic components of the two ultrasonic electrode components (1) and the ultrasonic vibration element (20), a circuit board module is typically placed outside the battery housing (4). The control chip and switches on the circuit board module control the internal ultrasonic components in the two ultrasonic electrode components (1) and in the ultrasonic vibration element (20). Meanwhile, the circuit board module can be equipped with Bluetooth or Wi-Fi communication capabilities, allowing the battery to be connected to the Internet and monitored or controlled via computers or smartphones.

I claim:

1. An ultrasonic solid-state battery structure capable of removing lithium dendrites, comprising:
two ultrasonic electrode bodies (1);
a solid electrolyte (2) disposed between the two ultrasonic electrode bodies (1);
and a separation assembly (3) connected to the two ultrasonic electrode bodies (1), which drives the two ultrasonic electrode bodies (1) respectively to come into close contact with or separate from the solid electrolyte (2),
wherein, when in a separated state, a separation gap (30) is formed between the ultrasonic electrode bodies (1) and the solid electrolyte (2).

2. The ultrasonic solid-state battery structure capable of removing lithium dendrites according to claim 1, wherein the solid electrolyte (2) further includes an ultrasonic vibration element (20) provided inside.

3. The ultrasonic solid-state battery structure capable of removing lithium dendrites according to claim 1, wherein the separation assembly (3) comprises two miniature electric push rods (31), and movable ends of the two miniature electric push rods (31) are respectively fixed to the two ultrasonic electrode bodies (1).

4. The ultrasonic solid-state battery structure capable of removing lithium dendrites according to claim 3, wherein a compression spring (32) is further provided between each miniature electric push rod (31) and the corresponding ultrasonic electrode body (1).

5. The ultrasonic solid-state battery structure capable of removing lithium dendrites according to claim 1, further comprising a battery housing (4) with a receiving cavity (41) and a battery housing cover (5), wherein the two ultrasonic electrode bodies (1), the solid electrolyte (2), and the separation assembly (3) are respectively fitted into the receiving cavity (41), the battery housing cover (5) is placed over an opening of the receiving cavity (41), and two terminals (51) electrically connected to the two ultrasonic electrode bodies (1) are provided on the battery housing cover (5).

6. The ultrasonic solid-state battery structure capable of removing lithium dendrites according to claim 5, wherein guiding protrusions (10) and guiding grooves (42) that slide in matching alignment are provided between the two ultrasonic electrode bodies (1) and a bottom of the receiving cavity (41), and guiding protrusions (10) and guiding grooves (42) that slide in matching alignment are also provided between the two ultrasonic electrode bodies (1) and the battery housing cover (5).

7. The ultrasonic solid-state battery structure capable of removing lithium dendrites according to claim 5, wherein a limiting protrusion (21) and a limiting groove (411), which mutually engage, are further provided between the solid electrolyte (2) and the receiving cavity (41).

8. The ultrasonic solid-state battery structure capable of removing lithium dendrites according to claim 5, wherein an air inlet (52) communicating with the receiving cavity (41) is provided on the battery housing cover (5), a debris-blowing outlet (43) communicating with the receiving cavity (41) is provided at a bottom of the battery housing (4), both the air inlet (52) and the debris-blowing outlet (43) include reusable sealing caps (6), and a funnel-shaped guide structure (44) is further provided between a bottom of the receiving cavity (41) and the debris-blowing outlet (43).

9. The ultrasonic solid-state battery structure capable of removing lithium dendrites according to claim 8, wherein a support bracket (7) is provided at the bottom of the receiving cavity (41) to support the two ultrasonic electrode bodies (1) and the solid electrolyte (2), and the support bracket (7) is formed with perforations (71) for debris passage.

10. The ultrasonic solid-state battery structure capable of removing lithium dendrites according to claim 2, wherein the two ultrasonic electrode bodies (1) and the ultrasonic vibration element (20) respectively comprise a housing (12) having a working cavity slot (11), a sliding block (13) disposed in the working cavity slot (11), and a cover shell (14) mounted over the working cavity slot (11), the sliding block (13) is provided with a permanent magnet (15), an electromagnetic coil (16) interacting with the permanent magnet (15) is provided on an inner side of the cover shell (14), buffering elastic pieces (17) are respectively provided at both ends of the sliding block (13), and surfaces of the housing (12) and the cover shell (14) are both coated with a conductive coating (18).
